(19) United States
(12) Patent Application Publication
(10) Pub. No.: US 2023/0341075 A1
(43) Pub. Date: Oct. 26, 2023

(54) HYDROGEN TRANSPORTATION PIPE AND HYDROGEN TRANSPORTATION PIPELINE

(71) Applicant: Shenzhen Leinier Technology Co., Ltd., Shenzhen (CN)

(72) Inventor: Chunming Huang, Shenzhen (CN)

(21) Appl. No.: 18/138,726

(22) Filed: Apr. 24, 2023

(30) Foreign Application Priority Data
Apr. 26, 2022 (CN) 202220982926.5

(51) Int. Cl. F16L 58/04; F16L 58/14; F16L 58/08

(52) U.S. Cl. CPC F16L 58/04; F16L 58/14; F16L 58/08

(57) ABSTRACT

Embodiments of the present application provide a hydrogen transportation pipe and a hydrogen transportation pipeline. A steel pipe body of the hydrogen transportation pipe has a pipe cavity with a round cross section; an inner wall of the pipe cavity of the steel pipe body is provided with a nano-composite coating used for preventing hydrogen atoms from diffusing into the steel pipe body; and an outer diameter of the steel pipe body is not more than 100 millimeters and a diameter of the pipe cavity of the steel pipe body is not more than 90 millimeters. According to the present application, a hydrogen embrittlement phenomenon can be prevented from occurring in the steel pipe body, and the transportation cost of hydrogen can be effectively reduced and the large-scale commercial application of the hydrogen energy can be further accelerated.

### CROSS REFERENCE TO RELATED APPLICATIONS

The present application claims the benefit of Chinese Patent Application No. 202220982926.5 filed on Apr. 26, 2022, the contents of which are incorporated herein by reference in their entirety.

### TECHNICAL FIELD

The present application relates to the technical field of hydrogen transportation, and in particular to a hydrogen transportation pipe and a hydrogen transportation pipeline.

### BACKGROUND

As an important chemical raw material, hydrogen is widely applied to petrochemical industry, organic synthesis, food industry, microelectronics industry, metallurgical industry, and silicate industry. During the industrial production process, it is necessary to transfer the hydrogen in a hydrogen storage device to a corresponding production unit by means of a hydrogen transportation pipe, so as to satisfy the demands of industrial on hydrogen as raw materials.

Compared with fossil energy sources, hydrogen energy is a type of clean, environment-friendly, and renewable secondary energy source, which plays a stable, reliable, and irreplaceable role in terms of implementing energy storage of renewable energy sources, and is an important part of an energy structure of China or the world in the future. Hydrogen power generation, hydrogen fuel cells and hydrogen automobiles are the important development trends of the future science and technology. In the field of hydrogen energy, it is required to transport hydrogen generated by a hydrogen generator using electric energy into the hydrogen storage device (equipment) by means of a hydrogen transportation pipeline. During the generation and utilization processes of the hydrogen energy, the hydrogen in the hydrogen storage device (equipment) needs to be transported to an energy conversion or production unit by means of the hydrogen transportation pipe to obtain corresponding energy.

Existing gas transportation pipes, e.g. natural gas transportation pipes, are mainly seamless steel pipes made of steel. If these seamless steel pipes are used for transporting hydrogen for a long period, hydrogen atoms or molecules will diffuse and be dissolved into the steel pipes to cause a hydrogen embrittlement phenomenon, which will decrease the mechanical properties of the seamless steel pipes, result in pipeline failure, and make it impossible to transport the hydrogen safely and reliably. Hydrogen embrittlement refers to mechanical damage of a metal due to the penetration of hydrogen into the metal causing loss in ductility and tensile strength, such as cracking and brittle failure inside the metal material. The hydrogen embrittlement can only be prevented, and cannot be eliminated once occurred.

To solve the above technical problems, researchers in this field use alloy materials such as a Monel alloy to manufacture hydrogen transportation pipes. The hydrogen transportation pipes manufactured by the Monel alloy can effectively resist the pitting corrosion and stress corrosion cracking, caused by the hydrogen atoms or molecules, to transportation pipe bodies.

However, it is found by the inventor that existing hydrogen transportation pipes manufactured by the Monel alloy at least have the following limitations:

Seamless steel pipes manufactured by the Monel alloy are high in cost and are mainly used in marine engineering, crude oil distillers, and industrial heat exchangers. If the hydrogen transportation pipes manufactured by the Monel alloy are adopted, the large-scale commercial application of the hydrogen energy will be hindered because of the cost.

### SUMMARY

In view of this, embodiments of the present application relate to a hydrogen transportation pipe and a hydrogen transportation pipeline, which is used for solving the disadvantages in the prior art that hydrogen transportation pipes manufactured by a Monel alloy are high in cost and large-scale commercial application of hydrogen energy is hindered. In the embodiments of the present application, a steel pipe body that is used for natural gas transportation is provided with a nano-composite coating having a dense structure, and the nano-composite coating can effectively prevent hydrogen atoms from permeating and diffusing into the steel pipe body to prevent a hydrogen embrittlement phenomenon from occurring in the steel pipe body. Therefore, a pipe for transporting hydrogen can be manufactured by using a common steel pipe for transporting natural gas with nano-composite coating. Also, a corresponding hydrogen transportation pipeline can be constructed by the resulting pipe. Using such pipeline will reduce the transportation bills of hydrogen and further accelerate the large-scale commercial application of the hydrogen energy.

To achieve the above objectives, technical solution adopted in the embodiments of the present application is as follows:

In a first aspect, an embodiment of the present application provides a hydrogen transportation pipe; a steel pipe body of the hydrogen transportation pipe has a pipe cavity with a round cross section; an inner wall of the pipe cavity of the steel pipe body is provided with a nano-composite coating used for preventing hydrogen atoms from diffusing into the steel pipe body; and an outer diameter of the steel pipe body is not more than 100 millimeters and a diameter of the pipe cavity of the steel pipe body is not more than 90 millimeters.

In a possible implementation, the thickness of the nano-composite coating is from 0.5 microns to 5 microns.

In a possible implementation, the nano-composite coating is a multi-component coating which is arranged on the inner wall of the pipe cavity of the steel pipe body through a vacuum sputtering process.

In a possible implementation, the nano-composite coating is an alloy coating or a ceramic coating.

In a possible implementation, the alloy coating is a W/ZnAl coating.

In a possible implementation, the ceramic coatings are the Al/Al₂O₃ and TiN/AlN coatings.

In a second aspect, an embodiment of the present application provides a hydrogen transportation pipeline, and the hydrogen transportation pipeline includes the foregoing hydrogen transportation pipe.

On the basis of the above technical solutions, in the embodiments of the present application, the common steel pipe body that can be used for transporting the natural gas is provided with the nano-composite coating with the dense structure. The nano-composite coating, serving as a barrier between the steel pipe body and a hydrogen environment, can effectively prevent the hydrogen atoms from permeating and diffusing into the steel pipe body. And the diffusion coefficient of hydrogen to the steel pipe body decrease by several orders of magnitude after the coating adding. Therefore, the common steel pipe with the nano-composite coating can effectively prevent the hydrogen embrittlement phenomenon from occurring in the steel pipe body, which ensure that a corresponding pipeline constructed by such steel pipe can be used for transporting the hydrogen in a highly reliable and safe manner for a long time. Also, the nano-composite coating is dense and has advantages such as a strong bonding force with the steel pipe body, high thermal stability, and strong thermal shock resistance. In this way, without using Monel alloy pipes with high cost, using the common steel pipe decorated with nano-composite coating to construct pipeline for transporting the hydrogen will effectively reduce the transportation cost of hydrogen and further accelerate the large-scale commercial application of the hydrogen energy.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and for a person of ordinary skill in the art may still derive other drawings from these accompanying drawings without creative efforts.

FIG. 1 shows a composition schematic diagram of an application environment of an embodiment of the present application.

FIG. 2 shows a cross section schematic diagram of a hydrogen transportation pipe in an embodiment of the present application.

FIG. 3 shows a structural schematic diagram of a hydrogen transportation pipeline in an embodiment of the present application.

A corresponding relationship between reference numerals in the drawings and part names is as follows:
1: hydrogen transportation pipe, 101: steel pipe body, 102: pipe cavity, 103: nano-composite coating, 2: transportation pipe coupling piece, 3: valve.

### DETAILED DESCRIPTION

To make the objectives, technical solutions, and advantages of the embodiments of the present application clearer, the following clearly and completely describes the technical solutions in the embodiments of the present application with reference to the accompanying drawings in the embodiments of the present application. Apparently, the described embodiments are some but not all of the embodiments of the present application. All other embodiments obtained by a person of ordinary skill in the art based on the embodiments in the present application without creative efforts shall fall within the protection scope of the present application.

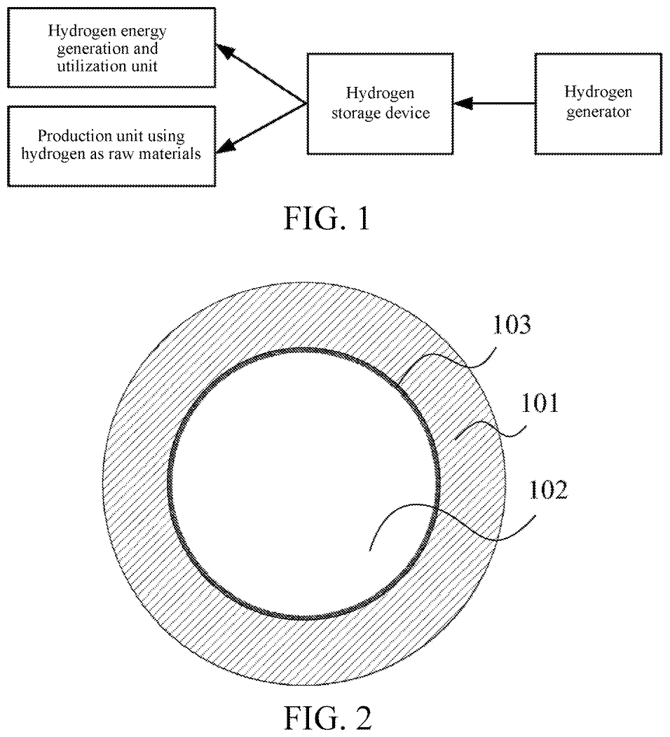

FIG. 1 shows a composition schematic diagram of an application environment of an embodiment of the present application. A hydrogen transportation pipe provided by an embodiment of the present application is used for constructing a hydrogen transportation pipeline in an embodiment of the present application; and the hydrogen transportation pipeline in the embodiment of the present application is used for establishing pipeline connection between a hydrogen generator and a hydrogen storage device, or between the hydrogen storage device and a production unit using hydrogen as raw materials, or between the hydrogen storage device and a hydrogen energy generation and utilization unit, so as to realize the transportation of hydrogen.

Now referring to FIG. 1, the hydrogen generated by the hydrogen generator is transported, by means of the hydrogen transportation pipeline in the embodiment of the present application, into the hydrogen storage device for storage; the hydrogen stored in the hydrogen storage device is transported, by means of the hydrogen transportation pipeline in the embodiment of the present application, into the production unit using hydrogen as raw materials to obtain a corresponding industrial products; and the hydrogen stored in the hydrogen storage device is transported, by means of the hydrogen transportation pipeline in the embodiment of the present application, into the hydrogen energy generation and utilization unit to obtain power energy.

This application environment may only include the hydrogen generator and the hydrogen storage device. At this time, the application environment of the embodiments of the present application may specifically be a solar hydrogen production plant, a wind-hydrogen production plant, and a tidal-hydrogen production plant.

This application environment may only include the hydrogen storage device and the production unit using hydrogen as raw materials. At this time, the application environment of the embodiments of the present application may specifically be an industrial production workshop using hydrogen as raw material.

This application environment may only include the hydrogen storage device and the hydrogen energy generation and utilization unit. At this time, the application environment of the embodiments of the present application may specifically be a hydrogen power plant and a power generation system of hydrogen machinery (e.g. Hydrogen vehicles).

The composition of the application environment of the embodiments of the present application may be, but not limited to, the composition illustrated in FIG. 1. In practical application, corresponding functional units may be added to the composition illustrated in FIG. 1, so as to realize the corresponding hydrogen production and utilization.

It should be noted that the hydrogen transportation pipe and the hydrogen transportation pipeline provided by the embodiments of the present application have application scenarios that include, but are not limited to, hydrogen transportation, and they may also be applied to the construction of transportation facilities of other gases, e.g. natural gas.

FIG. 2 shows a cross section schematic diagram of a hydrogen transportation pipe in an embodiment of the present application.

Now referring to FIG. 2, in the hydrogen transportation pipe in the embodiment of the present application, a steel pipe body 101 of the hydrogen transportation pipe has a pipe cavity 102 with a round cross section; an inner wall of the pipe cavity 102 of the steel pipe body 101 is provided with a nano-composite coating 103 used for preventing hydrogen atoms from diffusing into the steel pipe body; and an outer diameter of the steel pipe body 101 is not more than 100 millimeters and a diameter of the pipe cavity 102 of the steel pipe body 101 is not more than 90 millimeters.

In a possible implementation, the material of the steel pipe body 101 may be the steel used for gas (e.g. natural gas) pipe manufacturing, e.g. stainless steel and carbon steel. Certainly, alloy steel may be adopted regardless of the cost, and be specifically determined according to application scenarios; and the structure of the steel pipe body 101 is a seamless steel pipe structure to ensure that the steel pipe body 101 has better mechanical properties.

In a possible implementation, the cross section of the pipe cavity 102 of the steel pipe body 101 of the hydrogen transportation pipe is round, and the steel pipe body 101 is of a round pipe structure. On one hand, pipeline joints of the steel pipe body 101 with the round pipe structure are the same as those of the hydrogen generator, the hydrogen storage device, the production unit using hydrogen as raw materials, and the hydrogen energy generation and utilization unit in terms of standards, which is convenient for adaptation and improves the system compatibility of the hydrogen transportation pipe. On the other hand, when the steel pipe body 101 with the round pipeline structure serves as a constituent part of the hydrogen transportation pipeline, the pressure inside the pipe cavity is distributed uniformly, and hydrogen are distributed uniformly, so as to not only facilitate the flowing of the hydrogen, but also facilitate a near uniform stress from a hydrogen flow on the nano-composite coating 103, thereby prolonging the service life of the nano-composite coating 103.

In a possible implementation, the outer diameter of the steel pipe body 101 is not more than 100 millimeters and the diameter of the pipe cavity 102 of the steel pipe body 101 is not more than 90 millimeters. On one hand, the hydrogen transportation pipe in the embodiment of the present application may be manufactured by adopting a commercially available standard steel pipe to reduce the cost of raw materials; on the other hand, the hydrogen transportation pipe in the embodiment of the present application may be obtained by adopting a steel pipe processing technology commonly used in the industry to reduce the cost of production.

In a possible implementation, the nano-composite coating 103 can prevent hydrogen atoms from diffusing into the steel pipe body, and is a multi-component coating which is arranged on an inner wall of the pipe cavity 102 of the steel pipe body 101 through a vacuum sputtering coating process. Its thickness may specifically be from 0.5 microns to 5 microns.

Specifically, various coating materials are prepared into a cathode target, for example, various coating materials such as Al (Aluminum) metal, W (Tungsten) metal, Zn (Zinc) metal, and Ti (Titanium) metal are prepared into a cathode target. The vacuum sputtering process is carried out in a vacuum chamber to form the multi-component nano-composite coating 103 by the following steps: (1) introducing argon or other inert gas into the vacuum chamber to get the pressure of 0.1 Pa to 10 Pa after the ultimate vacuum with 1×10⁻⁵ Pa; (2) taking the resulting target as a cathode and taking the inner wall of the pipe cavity 102 of the steel pipe body 101 as an anode; applying direct-current negative high voltage of 1 KV to 3 KV or radio frequency voltage of 13.56 MHz to the cathode target to generate a glow discharge; (3) the atoms are ejected from a target and are deposited on the inner wall of the pipe cavity 102 of the steel pipe body 101 and the formation of the nano-composite coating 103 occurs as a result of the bombardment of the target by argon ions obtained by ionizing the argon. In a case that only argon is introduced into the vacuum chamber, the obtained nano-composite coating 103 is an alloy coating, e.g. a W/ZnAl coating. In a case that the reactive gas (such as oxygen and nitrogen) is introduced into the vacuum chamber with a certain pressure with or without the addition of argon, the ionized reactive gas can react chemically with the atoms ejected from a target, which produce a molecular compound which then becomes the deposited metal oxides (e.g. Al₂O₃) or metal nitride (e.g. TiN) nano-composite coating 103 on the inner wall of the pipe cavity 102 of the steel pipe body 101. The nano-composite coating 103 is a ceramic coating, e.g. the Al/Al₂O₃ or TiN/AlN coating.

In a case that the alloy coating is the W/ZnAl coating or the ceramic coatings are the Al/Al₂O₃ and TiN/AlN coatings, the nano-composite coating 103 not only has advantages such as dense structure, high hardness and good friction resistance, but can also more effectively prevent the hydrogen atoms from permeating and diffusing into the steel pipe body so as to effectively prevent a hydrogen embrittlement phenomenon from occurring in the steel pipe body.

The hydrogen transportation pipeline in the embodiment of the present application includes the hydrogen transportation pipe provided by the embodiment of the present application.

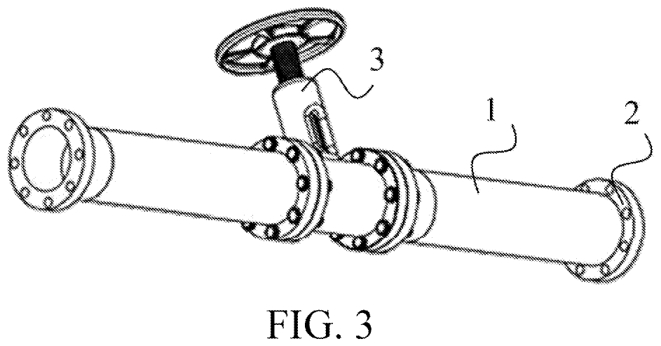

FIG. 3 shows a structural schematic diagram of a hydrogen transportation pipeline in an embodiment of the present application.

Now referring to FIG. 3, the hydrogen transportation pipeline is a device for transporting hydrogen, which is formed by coupling a hydrogen transportation pipe 1, a transportation pipe coupling piece 2, and a valve 3.

In a possible implementation, the valve 3 and the transportation pipe coupling piece 2 are corresponding parts used for a gas pipeline (e.g. a natural gas pipeline), in which the transportation pipe coupling piece 2 may specifically be a flange.

What is claimed is:

1. A hydrogen transportation pipe, wherein
a steel pipe body (101) of the hydrogen transportation pipe has a pipe cavity (102) with a round cross section; an inner wall of the pipe cavity (102) of the steel pipe body (101) is provided with a nano-composite coating (103) used for preventing hydrogen atoms from diffusing into the steel pipe body; and an outer diameter of the steel pipe body (101) is not more than 100 millimeters and a diameter of the pipe cavity (102) of the steel pipe body (101) is not more than 90 millimeters.

2. The hydrogen transportation pipe according to claim 1, wherein the thickness of the nano-composite coating (103) is from 0.5 microns to 5 microns.

3. The hydrogen transportation pipe according to claim 1, wherein the nano-composite coating (103) is a multi-component coating which is arranged on the inner wall of the pipe cavity (102) of the steel pipe body (101) through a vacuum sputtering coating process.

4. The hydrogen transportation pipe according to claim 3, wherein the nano-composite coating (103) is an alloy coating or a ceramic coating.

5. The hydrogen transportation pipe according to claim 4, wherein the alloy coating is a W/ZnAl coating.

6. The hydrogen transportation pipe according to claim 4, wherein the ceramic coatings are the Al/Al₂O₃ and TiN/AlN coatings.

7. A hydrogen transportation pipeline, wherein the hydrogen transportation pipeline comprises the hydrogen transportation pipe (1) according to claim 1.

8. A hydrogen transportation pipeline, wherein the hydrogen transportation pipeline comprises the hydrogen transportation pipe (1) according to claim 2.

9. A hydrogen transportation pipeline, wherein the hydrogen transportation pipeline comprises the hydrogen transportation pipe (1) according to claim 3.

10. A hydrogen transportation pipeline, wherein the hydrogen transportation pipeline comprises the hydrogen transportation pipe (1) according to claim 4.

11. A hydrogen transportation pipeline, wherein the hydrogen transportation pipeline comprises the hydrogen transportation pipe (1) according to claim 5.

12. A hydrogen transportation pipeline, wherein the hydrogen transportation pipeline comprises the hydrogen transportation pipe (1) according to claim 6.
